(19) United States
(12) Patent Application Publication
(10) Pub. No.: US 2001/0041326 A1
(43) Pub. Date: Nov. 15, 2001

(54) Simulator for aircraft flight training

(76) Inventor: Bruce E. Zeier, Romoland, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/774,777

(22) Filed: Jan. 30, 2001

Related U.S. Application Data
(63) Continuation-in-part of application No. 09/570,328, filed on May 12, 2000.

(51) Int. Cl. G09B 9/08

(52) U.S. Cl. 434/33

(57) ABSTRACT

A flight simulator apparatus capable of directing elevation, rotation, yaw, roll and pitch control of a an operators cockpit and linear motions in the horizontal x-y plane. A first linear actuator is engaged with a rotation actuator for providing motion about a vertical axis of rotation. The first actuator is enabled for vertical positioning of a gimbally mounted cockpit. A second actuator is engaged for positioning the cockpit using opposing linear hydraulic pistons. A third and fourth linear actuators, preferably linear motors drive the entire apparatus in mutually orthogonal horizontal directions for simulating linear inertial forces in the cockpit.

### BACKGROUND OF THE INVENTION

1. Field of the Invention

This invention relates generally to a Simulator For Helicopter Flight Training, and more particularly to a simulator that gives the pilot the functional feel of the relationship between the collective, cyclic, throttle and tail rotor controls by transmitting those movements into a unique hydraulic manifold and valve assembly. This simulator incorporates modular flight controls, which allow the helicopter flight simulator to easily be converted into an airplane flight simulator. When the simulator is in “Airplane Mode” it gives the pilot the functional feel of the relationship between the control yoke ,engine throttle control, propellor control, and rudder controls by transmitting those movements through a unique hydraulic manifold and valve assembly.

2. Description of Related Art

The following art defines the present state of this field:

Feuer, et. al. U.S. Pat. No. 5,791,903 describes a flight simulator for amusement rides simulating aircraft or space flight with visual presentations and motion having an operator station attached to a structural support frame through an articulating member providing unlimited angular rotation about a roll axis and limited angular rotation about a pitch axis. An electrical coupling concentric with a drive axle is rotatable through at least 360.degrees. about the roll axis.

Cicare, et. al. U.S. Pat. No. 5,678,999 describes an invention relating to a system for training helicopter pilots, more particularly to a system to be used as a highly efficient means for complementing present methods for training pilots. The object of the invention is avoiding the stress to which the trainee is subjected during the first flights and providing understanding of the helicopter behavior easily and without risk. The invention proposes a system basically comprised by a structure and a conventional helicopter permitting simulating stationary or translational actual flight without separating from the ground. The structure comprises a shiftable base having a support for free rotation of a frame from which the helicopter is suspended, so that it may raise and lower within set limits and also that it may be tilted to the sides in a restricted way. This giving the possibility of practicing various maneuvers, also considerably reducing the training cost.

McFarland, et al. U.S. Pat. No. 5,860,807 describes an invention providing a turbulence model that has been developed for blade-element helicopter simulation. This model uses an innovative temporal and geometrical distribution algorithm that preserves the statistical characteristics of the turbulence spectra over the rotor disc, while providing velocity components in real time to each of five blade-element stations along each of four blades, for a total of twenty blade-element stations. The simulator system includes a software implementation of flight dynamics that adheres to the guidelines for turbulence set forth in military specifications. One of the features of the present simulator system is that it applies simulated turbulence to the rotor blades of the helicopter, rather than to its center of gravity. The simulator system accurately models the rotor penetration into a gust field. It includes time correlation between the front and rear of the main rotor, as well as between the side forces felt at the center of gravity and at the tail rotor. It also includes features for added realism, such as patchy turbulence and vertical gusts in to which the rotor disc penetrates. These features are realized by a unique real time implementation of the turbulence filters. The new simulator system uses two arrays one on either side of the main rotor to record the turbulence field and to produce time-correlation from the front to the rear of the rotor disc. The use of Gaussian Interpolation between the two arrays maintains the statistical properties of the turbulence across the rotor disc. The present simulator system and method may be used in future and existing real-time helicopter simulations with minimal increase in computational workload.

Wachsmuth, et al. U.S. Pat. No. 4,710,128 describes a spatial disorientation trainer-flight simulator wherein a cockpit is gimballed on three independently-controlled axes, i.e., pitch, roll and yaw, which revolve about a planetary axis. Rotation of the cockpit about the planetary axis is controlled by a remote console computer. Rotation of the cockpit about the pitch and roll axes is controlled by an on board cockpit computer alone or in combination with the console computer. Rotation of the cockpit about the yaw axis is controlled by the console computer alone or in combination with the cockpit computer. Slip rings are employed at the planetary and yaw axes so as to provide 360.degree. cockpit rotation about each axis. Rotation about each of the pitch, roll and yaw axes is effected by a high torque direct drive dc motor under control of the computers. Smooth, continuous motor operation is possible over a wide range of speeds, including sub-threshold speeds not detectable by the pilot.

Akister and Shelley et. al. U.S. Pat. No. 3,597,857, describes a ground-based flight-simulating apparatus, where a dummy flight deck is provided for the crew being trained; where the dummy flight deck, with occupants, is moved to simulate at least pitch and roll movement of an aircraft in actual flight. The invention comprises a dummy flight deck suspended from a supporting structure by three hydraulic jacks attached to the dummy flight deck. Differential action of the jacks provides pitch and bank motions and common action provides heave motion. A further pair of hydraulic jacks attached, on opposite sides of the flight deck centerline, provides yaw, surge and retardation motions. A further hydraulic jack, acting transversely of the flight deck centerline, provides sway motion.

The prior art teaches various flight simulators, some of which enable motion in all six axes. However, the prior art does not teach a flight simulator apparatus with the ability to rotate continuously about a vertical axis and provide multiple effects with a single control imput using a powered linear actuating means. The present invention fulfills these needs and provides further related advantages as described in the following summary.

### SUMMARY OF THE INVENTION

The present invention teaches certain benefits in construction and use, which give rise to the objectives described below.

The present invention provides a flight simulator apparatus comprising a rotation actuating means providing a vertical axis of 360 degrees rotation for simulating yaw motion. A first linear actuating means is engaged with the rotation actuating means for allowing motion about the vertical axis of rotation, the first linear actuating means enabled for vertical positioning of a gimbal mounting means. A structural frame is engaged with the gimbal mounting means and is movable therewith. A cylindrical collar is slidably engaged on the first linear actuating means and positionable thereon, and a second linear actuating means is engaged with the cylindrical collar, the second linear actuating means being adapted for positioning the cylindrical collar on the first linear actuating means. A second linear actuating means is engaged between the cylindrical collar and the structural frame, the second linear actuating means enabled for positioning the structural frame for simulating pitch and roll motions thereof. The invention therefore allows the operator to simulate movements of a helicopter or an airplane.

With the addition of a planar X Axis kit installed below the simulator mounting base, the entire simulator will move in the longitudinal axis, as is determined by the longitude of the cabin at the initial starting point of the simulation, thus simulating acceleration, thrust or G forces, dependant upon the duration or movements and planar position of the cabin once the simulation begins and the corresponding, ever changing, position of the cabin to the X Axis. This planar X Axis thus represents the third linear actuating means wherein the entire simulator, inclusive of it's self contained previously stated motion axis, will be free to move back and forth in a planar action about the hypothetical X Axis. Regardless of whether the simulator is in Helitrainer or Planetrainer mode, the third linear actuating means is controlled by software of the onboard computer and comparitor system and will be integrated to coincide with individual computer gaming or simulator functions as may be developed in the future.

The addition of a planar Y Axis kit installed below the simulator mounting base and also below the planar X Axis kit, will allow the entire simulator and optional X Axis kit if installed, to move in the lateral axis, which is perpendicular to the longitude of the cabin at the initial starting point of the simulation, thus simulating acceleration, thrust or G forces, dependant upon the duration of movement and planar position of the cabin once the simulation begins and the corresponding, ever changing, position of the cabin to the planar Y Axis. This planar Y Axis thus represents the fourth linear actuating means wherein the entire simulator, inclusive of it's self contained previously stated motion actions, will be free to move back and forth in a planar action about the hypothetical Y Axis. Regardless of whether the simulator is in Helitrainer or Planetrainer mode, the fourth linear actuating means is controlled by software of the onboard computer and comparitor system and will be integrated to coincide with individual computer gaming or simulator functions as may be developed in the future.

With the inclusion of both the planar X Axis and planar Y Axis kits to the base of the simulator, allows the simulator may allow directional movement in an Omnidirectional manner relative to the simulator base horizontal plane, that is, the simultaneous operation of both the planar X Axis and planar Y Axis creating an omnidirectional acceleration, thrust or G force feeling in the cabin. An example of a practical application of this motion is the combined effects of a skidding turn in an aircraft, wherein the aircraft (either helicopter or airplane) is performing an uncoordinated left turn such that the cabin is tilting left while an outward G force is felt, as opposed to a coordinated turn in which no outward G force is felt.

The present invention, when operational as a helicopter flight simulator or “Helitrainer,” has a unique correlation effect which most closely resembles the actual effect of torque on an operational helicopter. As the collective lever (vertical motion control) is increased, the cabin of an operational single main rotor helicopter will torque or yaw in either the right or left direction dependent upon the direction of the main rotor system rotation. In piston driven helicopters, the throttle has a similar correlated effect. The Helitrainer is unique in that it provides full and continuous 360 degree rotation, plus the correlated throttle and collective effect on the cabin movement. Thus, with the input of a single control, e.g., the collective, the simulator may produce more than one action, e.g., vertical lift and rotation. For example, if the operator lifts the collective control without any tail-rotor pedal input, then the cabin will raise in the heave axis (vertical translation) while simultaneously rotating about the yaw axis (vertical axis) in a correlated manner. If the collective is raised ½ travel, then the cabin will heave up approximately one-half travel inducing a corresponding rotational movement of ½ maximum rotational speed. The cabin will continue to rotate until the operator applies the appropriate input to stop the cabin rotation. This input could be either addition of the appropriate tail rotor pedal or, the reduction of the collective lever to the original position, or a combination of both control movements. The same relationship is true with the throttle, everything else staying the same, if the throttle is increased, then the cabin will rotate in the yaw axis until the appropriate input (application of tail rotor pedal) is applied. If everything else again stays the same and the same throttle input is removed, then the cabin will rotate opposite of the original direction until the previous tail-rotor input is removed.

This correlation effect is possible because all flight controls are “fly by wire” meaning that the mechanical control inputs are immediately converted to electrical signals. These electrical signals are then processed by software of the onboard computer and a comparitor that determines the signal strength and direction of the collective, the throttle, and the tail rotor pedals, and determines the corresponding amount of rotation required, if any, and also which direction, left or right. The throttle, collective and tail rotor pedals may be isolated electrically via switches on the instrument console, allowing the operator to focus on individual controls and their respective cabin reactions.

In addition to a collective, throttle and tail rotor pedals, the Helitrainer also includes a “cyclic control” which when manipulated, converts the mechanical movement of the control joystick into electrical signals. These signals are then processed by software and an onboard computer and comparitor, which in turn actuates control valves to energize the fore/aft and left/right cabin tilt servos, and the second linear actuating means. The cyclic control Ooystick) operates independently of the correlation system and can be isolated by a skill level switch on the instrument panel. Therefore, the operator may practice operating the cyclic system without the possible confusion of additional control inputs and resulting simulator reactions.

The present invention, when operational as an airplane flight simulator or “Planetrainer,” then uses a standardized control yoke, rudder pedals and control/instrument console manufactured for the computer gaming industry, that in turn replicate the control systems found in most airplanes. These controls include throttle control, propellor controls, retractable landing gear, flaps and numerous other airplane specific controls. The gaming controls then act upon the hydraulic/pneumatic system to induce motion to the simulator cabin simulating forces acting upon a real airplane while on the ground or in flight. This is possible because again, the flight controls are all “fly by wire” meaning that the mechanical airplane gaming control inputs are immediately converted to electrical signals. These electrical signals are then processed by software, an onboard computer and comparitor that determines the signal strength and direction of the control yoke, rudder pedals, or any other airplane specific control actions, and determines the corresponding amount of simulator cabin motion required, if any, to correspond to the given control(s) input. When in the “Planetrainer” mode, the simulator is unique in that it provides full and continuous 360 degree rotation which could be used to simulate such airplane specific, real life actions such as a flat spin, without the endangering the operator who would otherwise be forced to demonstrate a potentially dangerous flat spin in a real aircraft.

Helitrainer/Planetrainer incorporates an electric motor power source using a servo-motor which provides for variable hydraulic flow delivery to instantly increase or decrease flow supply dependent upon the number of control input demands and the corresponding degree of control input selected. This is accomplished by an electronic comparitor that monitors both the type of control input: collective, cyclic, throttle, rudder, tail rotor, planar X and Y axis, as well as the degree of that input, and adjusts the source voltage to the electric motor which in turn raises or lowers the motor RPM correspondingly increasing or decreasing hydraulic/pneumatic flow.

Helitrainer/Planetrainer may be powered by a gasoline powered motor directly attached to the hydraulic/pnuematic pump which is mounted in the cabin, or below the cabin on the lower rotating base plate. The Helitrainer/Planetrainer may also be powered by an electrical motor mounted in the cabin, or below the cabin on the lower rotating base plate All electric motor versions incorporate specially designed commutator rings mounted on the stationary base of the unit on a horizontal plane, and/or about the vertical plane mounted upon a vertical strut support mechanism, with adjustable brushes that are attached to the rotating portion of the Helitrainer/Planetrainer. Thus, the source voltage is routed from one or both stationary bases through the stationary commutator rings and rotating brushes, then to the electric motor. In either the gas engine or electric version, both motors are connected to the hydraulic/pneumatic pump/reservoir. In either gas or electric versions, commutator rings and brushes may also be used to transfer electrical signals to an externally mounted computer, and/or audio or video sources or systems.

Helitrainier/Planetrainer incorporates a unique internal locating shaft on the heave servo which prevents the heave piston shaft from rotating internally when the yaw axis is shifted from right to left, thus eliminating any external cylinder locating device and greatly simplifying the maintenance, reducing manufacturing costs, and improving the external appearance of the unit. This is accomplished by broaching a non round hole within the heave piston, a corresponding engaging non round shaft welded to the internal base of the cylinder wall which continually maintains contact with the internal non round broached hole of the piston rod, and incorporating a seal assembly if needed. Thus, as the piston moves up and down in the heave axis, this internal locating device prevents the cabin and piston shaft from moving relative to the yaw axis motor housing and cylinder wall assembly which is fixed to it.

Helitrainier/Planetrainer incorporates an optional unique modular external non rotating mechanism which may be added as a supplement to the internal locating device, or may act as a substitute for the internal device. This external mechanism may be chosen as a substitute or a supplement to the internal locating device dependant upon the environmental demands of the end user such as the desire to increase the gross weight capability of the passenger cabin.

This is accomplished by the fabrication of multiple vertical alinement rods threaded approximately one inch from one end which have a smooth exterior along the remaining rod length. The threaded end of each alinement rod is then screwed into corresponding multiple drilled and tapped holes in the cylindrical collar located on the vertical piston of the heave axis. The cylindrical collar has two machined groves within the inner bore which positively lock against two corresponding posts welded onto the exterior of the vertical rod of the heave axis. These grooves then lock the cylindrical collar to the vertical piston and retain the stationary relationship between the vertical alinement rods and the vertical piston. These vertical alinement rods, which are in the vertical position paralleling the motion of the heave axis piston rod assembly, move vertically in synchronization with the vertical (heave axis) piston rod. The lower end of these locating rods are then engaged in corresponding bored holes in the upper support bearing inner race adapter, which is mechanically locked to the top of the exterior wall of the vertical cylinder. These bored holes have bushings pressed into them which have the inner diameter coated with a self lubricating material such as teflon. This self lubricating material is then the contact surface between the stationary inner race adapter and the moveable vertical alinement rods. Thus, as the vertical rods move up and down in synchronization with the heave piston, the contact area of the inner race bearing bores prevent the rotation of the heave piston relative to the exterior cylinder wall, when the rotational loads are alternated from right rotation to left rotation about the yaw axis.

When utilizing the cabin mounted motor and hydraulic/pnuematic pump and reservoir, the Helitrainer/Planetrainer incorporates a unique internal hydraulic passage system for the heave axis servo by drilling the top of the servo piston and porting both up and down heave fluid exchanges between the cabin and the servo without exposing external fluid lines to the vertical movement of the servo itself. Thus, the only movement of the up/down heave servo lines is a slight angular movement when the cabin tilts left/right or fore/aft. This results in shortening and less wear on the flexible lines in addition to removing the appearance of two additional external fluid lines from the exterior view of the aircraft. Therefore, only two fluid lines (for rotation) and two electrical supply lines are exposed below the cabin and are subject to up/down heave of the cabin. All other controls and fluid transfers are internal to the cabin structure of the aircraft.

When utilizing the lower rotating base plate mounted motor and hydraulic/pnuematic pump and reservoir, the Helitrainer/Planetrainer incorporates an external hydraulic passage system for the fore/aft cabin tilt, and the left/right cabin tilt servos. This is accomplished by boring and tapping four holes in the upper support bearing inner race adapter (inner race adapter) which are then used to insert hydraulic/pnuematic fittings to pass hydraulic fluid or compressed air from below the upper bearing support inner race adapter, to above the inner race adapter and onward to the two cabin tilt servos. There are also two additional holes bored into the inner race adapter which are utilized for electrical conduits. Therefore, the inner race adapter has the following features; (1) four hydraulic/pneumatic transfer holes, (2) two electrical conduit holes, (3) four bearing bores for the external non rotating device rods, and (4) a spare hole for future use. Finally, the inner race adapter is mechanically indexed to the exterior cylinder wall of the vertical heave cylinder to prevent rotation of the inner race adapter when loaded by the vertical non rotating rods about the yaw axis of the cabin piston rod.

A primary objective of the present invention is to provide a flight simulator apparatus having advantages not taught by the prior art.

A further objective is to provide a compact flight simulator for developing the human motor skills necessary to hover an operational helicopter in a coordinated manner and provide the necessary controls and actuation devices to simulate mechanical failures and adverse environmental conditions.

A further objective is to provide a compact flight simulator for developing the human motor skills necessary to manuever an operational airplane in a coordinated manner and provide the necessary controls and actuation devices to simulate mechanical failures and adverse environmental conditions.

A further objective is to provide a flight simulator apparatus that can move about three orthogonal axis' simultaneously as well as move vertically.

A further objective is to provide a flight simulator apparatus that can move either about a planar X axis, a planar “Y” axis, or when in combination of both X and “Y” axis a resulting planar “Omnidirectional” axis. Therefore, a combined potential of three orthogonal axis, one vertical axis, and either planar “X,” a planar “Y,” or “Omnidirectional” X plus Y axis may be attained simultaneously.

A still further objective is to provide a flight simulator apparatus that provides correlation between controls in a manner simulating an operational helicopter.

A still further objective is to provide a flight simulator apparatus that provides correlation between controls in a manner simulating an operational airplane.

A yet further objective is to provide a simulator capable of simulating helicopter and fixed wing aircraft motions during failure of mechanical systems onboard a real aircraft.

A yet further objective is to provide a simulator capable of demonstrating and allowing the practicing of recovery methods to either helicopter and fixed wing aircraft motions during failure of mechanical systems, or those adverse encounters resulting from environmental conditions such as weather.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of the present invention showing simulated yaw motion in the preferred embodiment;

FIG. 2 is similar to FIG. 1 but showing simulated pitch motion thereof;

FIG. 3 is a breakaway close-up view of the central portion of FIG. 1 showing certain details thereof.

FIG. 4 is similar to FIG. 3 showing the interior frame assembly thereof;

FIG. 5 is similar to FIG. 4 illustrating motion of the interior frame assembly thereof;

FIG. 6 is a schematic diagram of the support system thereof showing means for vertical and rotational manipulation of the invention;

FIG. 7 is a schematic diagram of a control circuit thereof;

FIG. 8 is a block diagram showing signal logic thereof;

FIG. 9 is a further schematic diagram thereof;

FIG. 10 is a still further schematic diagram thereof;

FIG. 11 is a perspective view similar to FIGS. 1 and 2 showing alternate placement of a hydraulic accumulator;

FIG. 12 is a perspective view thereof showing a base support system for X-Y motion actuation; and

FIG. 13 is a side elevational sectional view taken along lines 13-13 in FIG. 12.

### DETAILED DESCRIPTION OF THE INVENTION

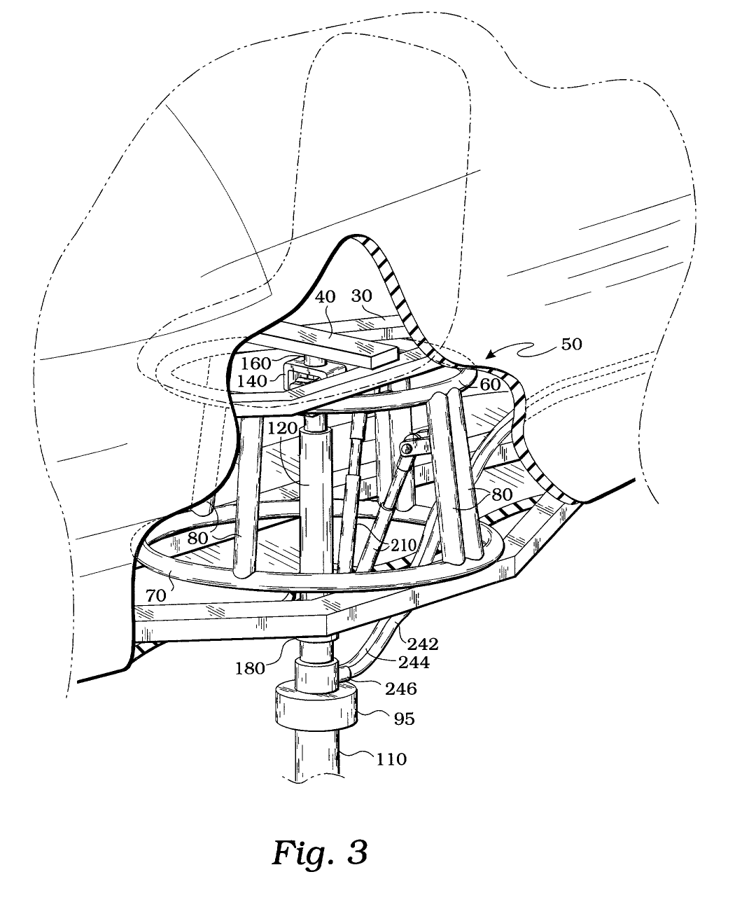

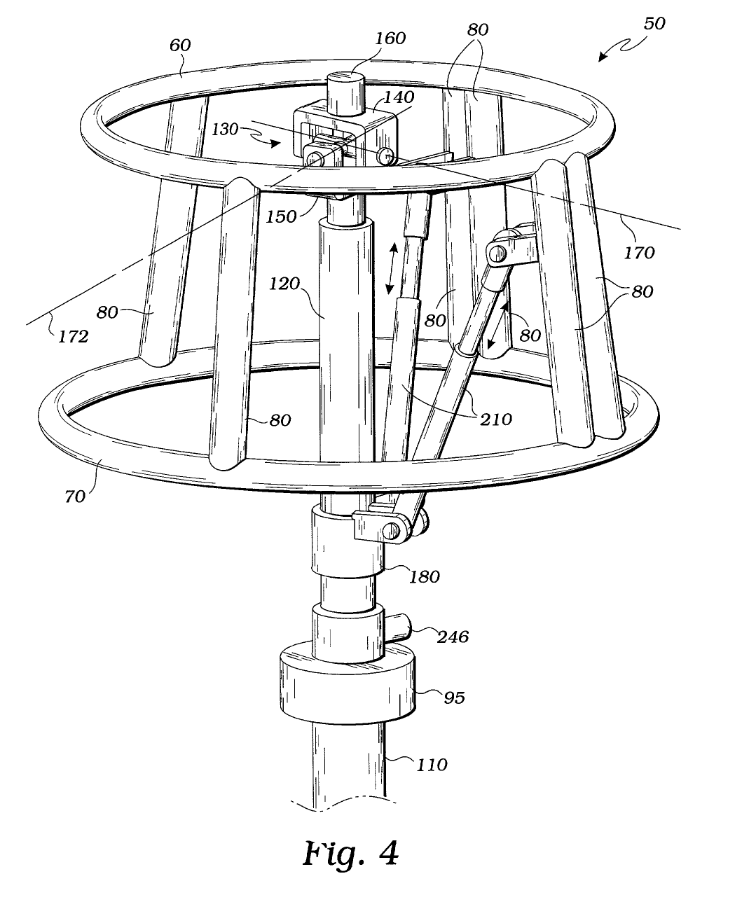

The above drawing figures illustrate the invention, a flight simulator apparatus comprised of a structural frame 10 which includes an airframe simulated helicopter/airplane cockpit 20 which is movable with elevation, yaw, roll, pitch, and planar X, and Y axis movements. As shown in FIG. 3, the cockpit 20 rests on a supporting frame 30 constructed as necessary for taking dynamic loads, and is joined by a medially placed crossbar 40 to a gimbaled mounting means 130 which is a mechanical manipulator described in more detail below and as shown in FIG. 4.

A mounting assembly 50 is comprised, in the preferred embodiment, of two rings 60, 70 oriented horizontally and joined by struts 80, as shown in FIGS. 3, 4, the upper ring 60 being smaller in diameter than the lower ring 70.

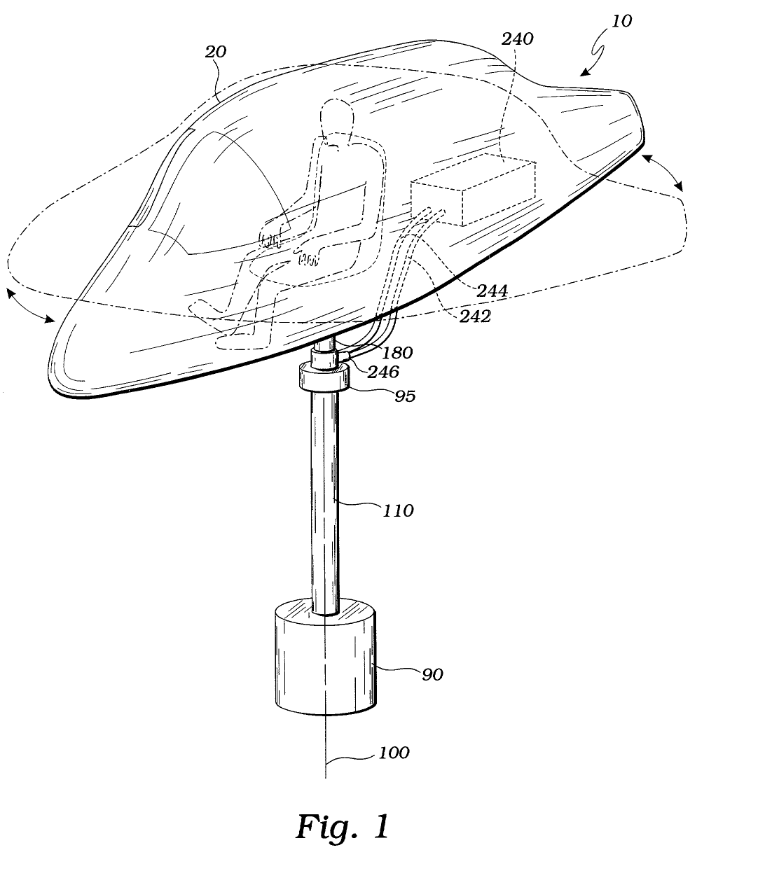

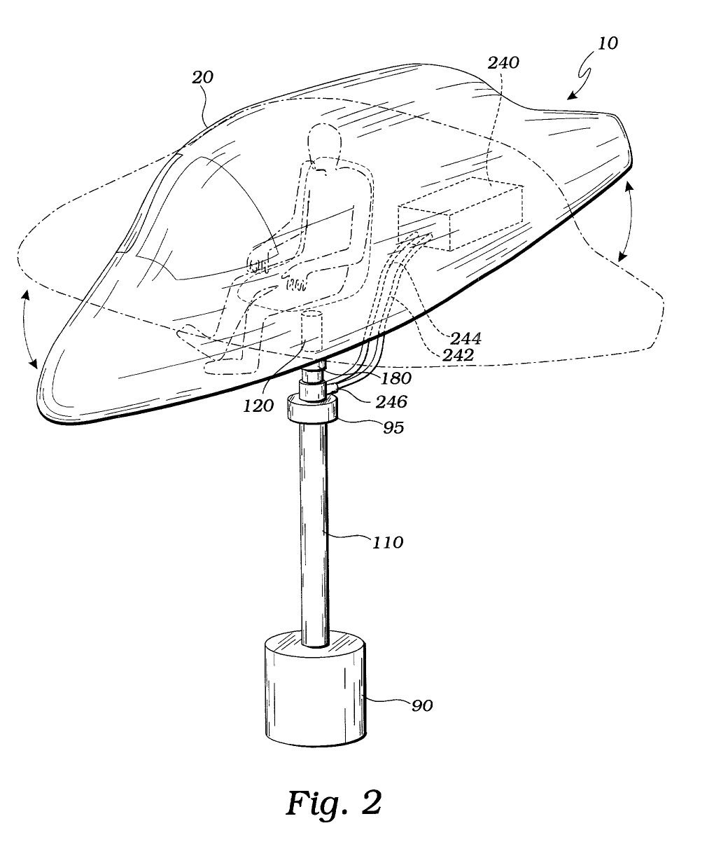

A rotation actuating means 90, preferably a hydraulic motor, but alternately a pneumatic, or an electrical rotating machine such as a stepping motor, provides rotation in both senses about a vertical axis of rotation 100 (FIG. 1). A first linear actuating means 110, as shown in FIGS. 1-3 is preferably comprised of a hydraulic cylinder, but alternately of a pneumatic cylinder or linear motor, and provides inner piston 120 enabled for vertical extension under hydraulic or pneumatic pressure or electrical force relative to an outer cylinder. The axially vertical orientation of the rotation actuating means 90 and the first linear actuating means 110 allows the apparatus to simulate the yawing motions of an aircraft, which are horizontally directed angular rotations of the aircraft about the vertical axis 100 as shown in FIG. 1.

Motions of the first linear actuating means 110 enables vertical positioning of the gimbaled mounting means 130, which is comprised of two U-shaped brackets 140 (upper) and 150 (lower). The upper gimbal bracket 140 supports a shaft 160 extending upwardly, and terminating fixedly to cross bar 40 on the supporting frame 30, as shown in FIG. 3.

The gimbaled mounting means 130 allows the cockpit 20 to rotate about a pair of orthogonal horizontal axis 170, 172 (FIG. 4) to simulate, respectively, the pitch and roll motions of an aircraft.

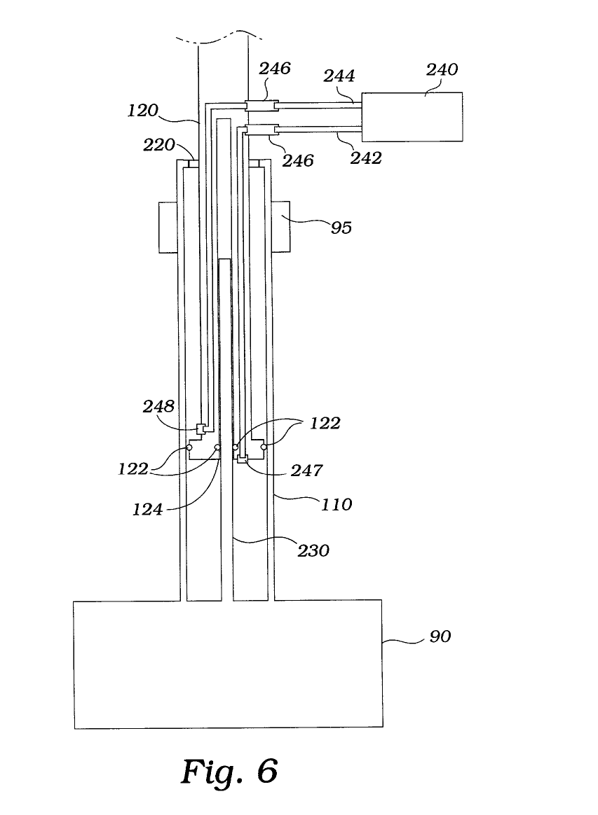

The first linear actuating means 110, a pressure cylinder, as shown in FIG. 6 schematically, comprises the inner piston 120 enabled, via seals 122, for linear movement. Hydraulic accumulator 240 produces hydraulic pressure, which is transferred through lines 242 and 244 and is enabled for entry into inner piston 120 via rotational joints 246. Hydraulic outlet 247 enables pressure changes below the piston 120 for moving the piston 120 upwardly within the actuating means 110, and hydraulic outlet 248 enables pressure changes above the seals 122 within actuating means 110 to effect piston 120 motion downwardly. As defined below, an alternate configuration may be used and this will be described in detail.

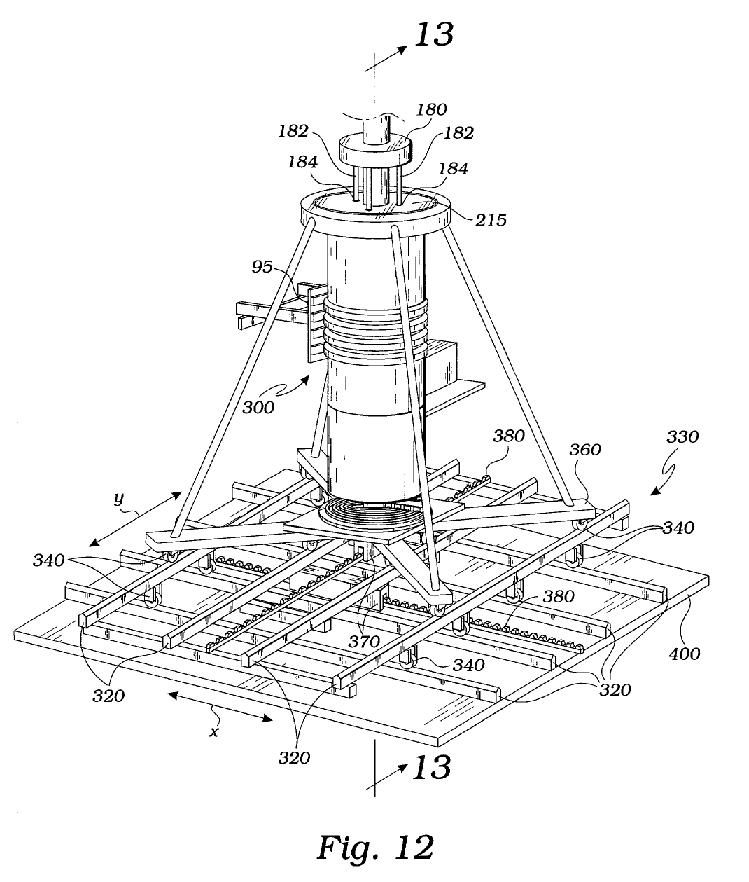

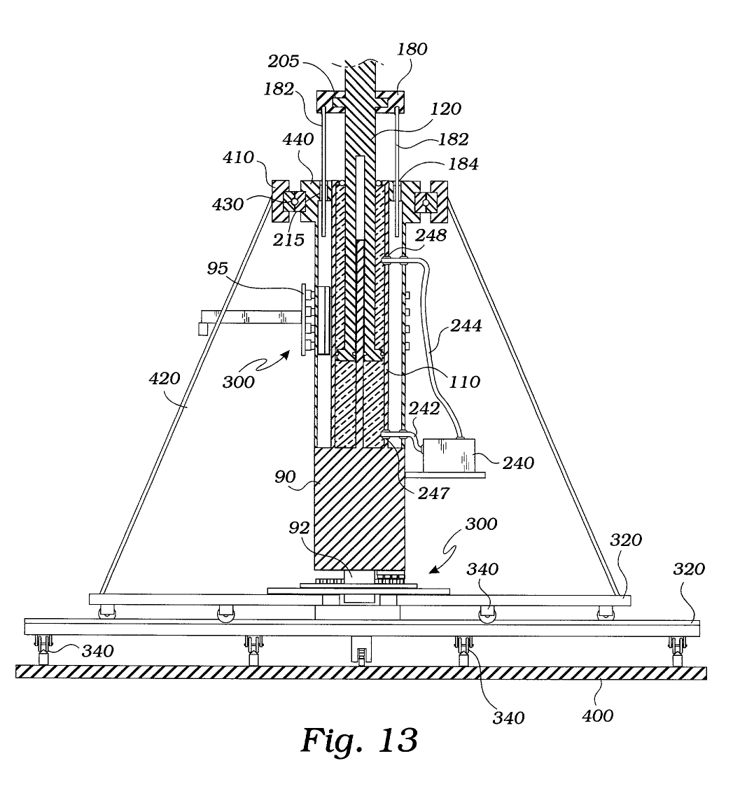

Rotation actuation means 90 provides rod 230 which protrudes upwardly within inner piston 120 for transferring rotational force to the piston 120 which would otherwise be free to rotate within first linear actuating means 110. Rod 230 is non-round so that piston 120 rotates with rod 230 and yet is able to translate relative to it under hydraulic pressure. A second non-rotational element, as shown in FIGS. 12 and 13, are exterior alignment rods 182 which are fixed to piston 120 through engagement with cylindrical collar 180 which is mechanically engaged and rotationally and axially synchronized with piston 120 by interlocking tabs 205, integral with piston 120. The alignment rods 182 then travel with vertical motion along with piston 120 and engage the upper support bearing inner race adapter 215 through self lubricated bushings thereby resisting rotation actuation means 90 in either left or right rotational directions. Inner race adapter 215 is mechanically engaged with linear actuation means 110 and rotates with it.

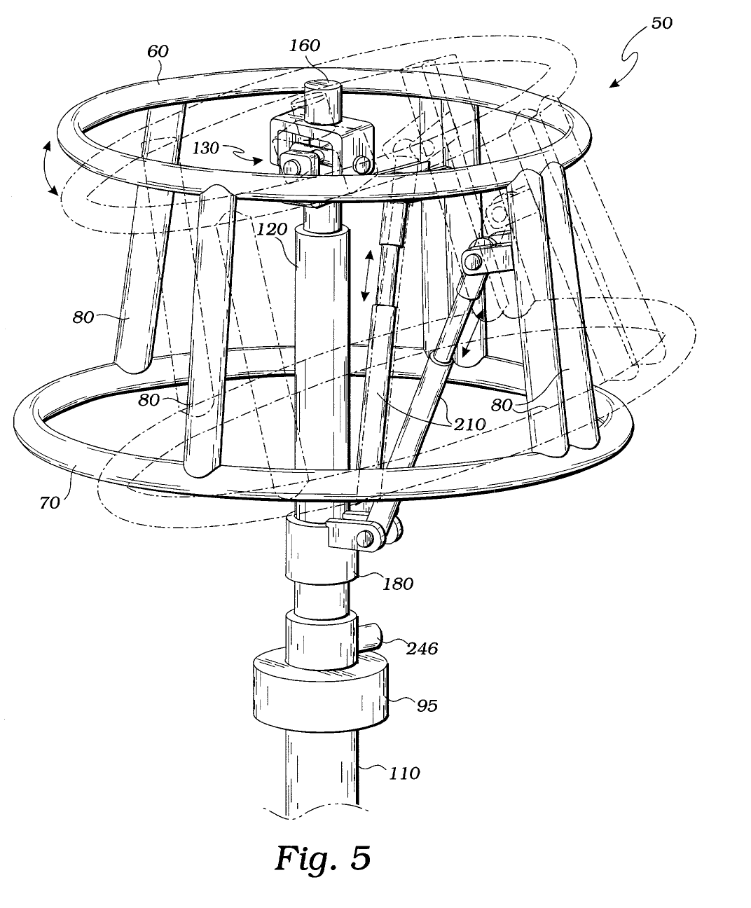

A second linear actuating means 210, preferably comprised of a pair of hydraulic cylinders, but alternately comprised of three, four, or more such cylinders, is pivotally connected between the cylindrical collar 180 and the mounting assembly 50, as shown in FIGS. 4 and 5. The two cylinders of the second linear actuating means 210 can act together, both extending and contracting together to simulate pitching motion, or in contravention to each other, one extending while the other one contracts in the directions shown by arrows in FIG. 4, thereby simulating roll motions thereof, as shown in FIGS. 4 and 5 wherein the later figure shows a phantom view of the mounting assembly 50 to depict rolling motion of the cockpit 20. Hydraulic lines are connected to the second linear actuating means 210 for operation thereof, but are not shown in the figures for clarity.

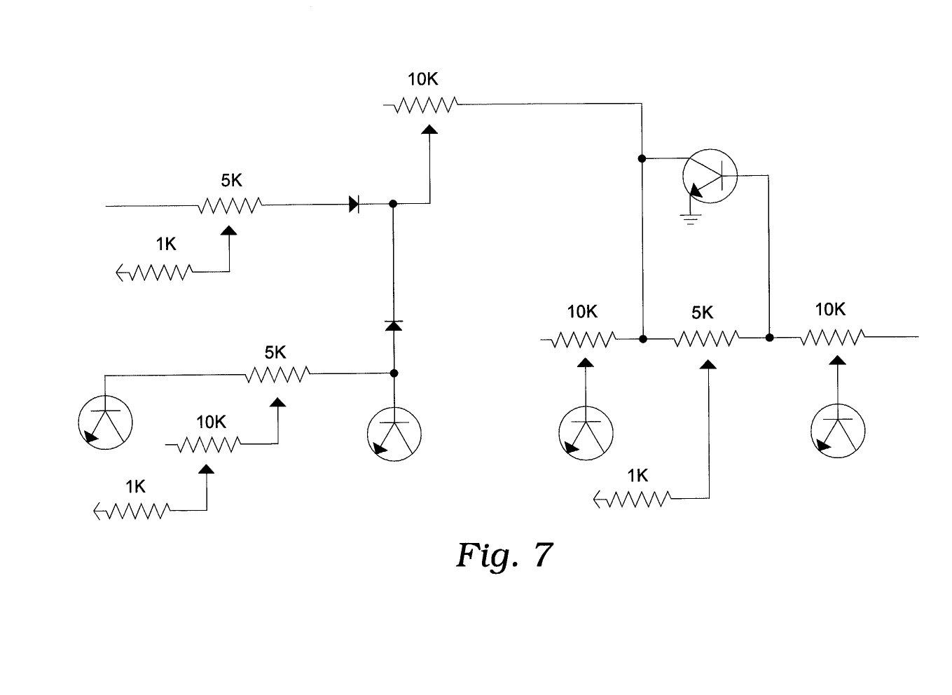

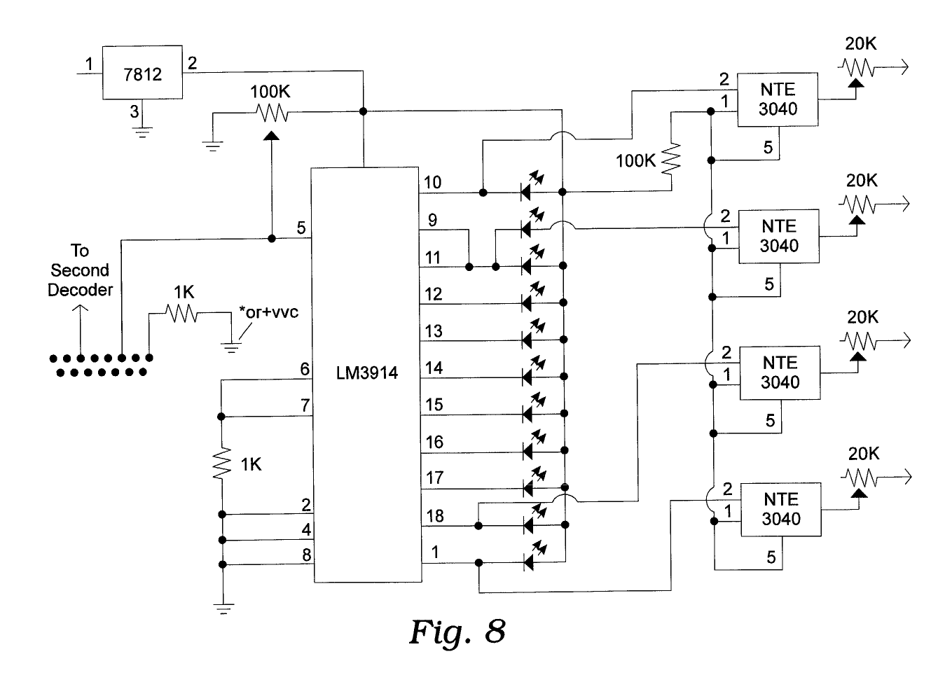

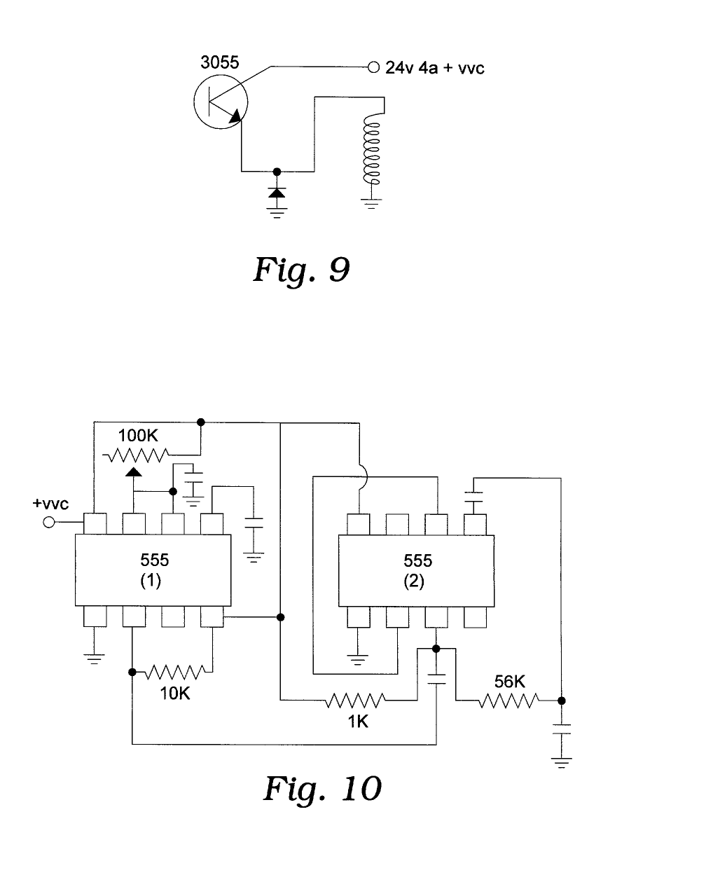

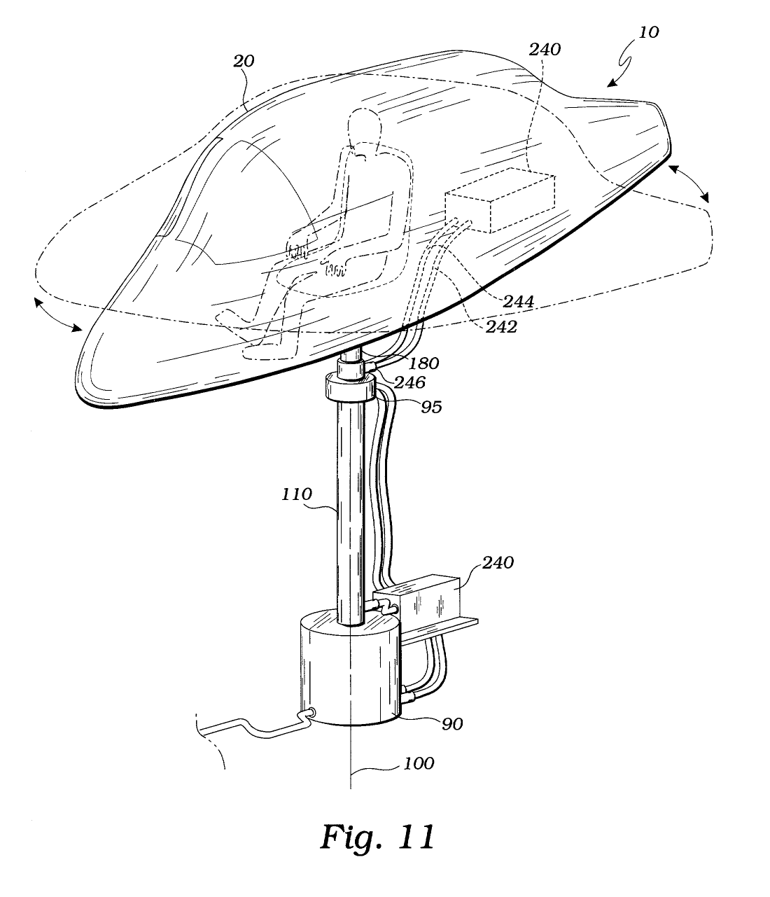

FIG. 7 defines a yaw comparitor circuit showing elements defined for collective control, collective sensitivity, yaw sensitivity right and left, yaw control and throttle control. FIG. 8 defines a circuit for comparing collective and throttle positions and determining the resultant change, if any, in rotational motion of the cockpit 20. FIG. 9 is a switching stage, output transistor, for actuating a solenoid coil L1 of the system. FIG. 10 shows a 70 to 100 Hz. oscillator circuit.

Although several combinations are possible, a software instruction set or software program of the invention provides for an increase in the “throttle” or “collective” helicopter controls to change the bias of the yaw control causing the cockpit to rotate. This then requires a manual movement of the opposite tail-rotor pedal by the pilot to cancel the effect. This simulates the forces in an actual helicopter and helps the flight student to build the coordination necessary as a helicopter pilot. In addition, by remotely controlling transistor bias, failures, thermals, and even wind effects are simulated. Circuit operation is relatively simple. A 7812 IC provides a stable voltage of 12 VDC to an LM3914 comparitor chip. The comparitor divides an output from a joystick into IO discreet steps. The steps are displayed on LEDs or similar light display. The 3914 is wired for “dot” mode. A 200k potentiometer is used to center the LED display. The joystick pot is grounded through a 2 K resistor. When moved, current from the 3914's input pin is allowed to go to ground changing the comparitor's input voltage compared to it's internal reference voltage. This causes the LED display to move up or down respectively. The outputs from the 3914 are read by a set of 3040 optoisolators. It is necessary to use the isolators because the output from the 3914 is linear and is prone to false triggering. Output from the 3040 is sent through a 20 K multi-turn potentiometer allowing fine adjustment of output current to proportioning valves. In addition, a 200 Hz. Oscillator, shown in FIG. 10, can be used with the 3055 output stage to “pulse” the proportioning valves. The bias of it's 100 K pot allows changes in pulse width for servo like control of the valves as well.

FIGS. 12, and 13 show a planar X-Y axis support system, which may be referred to as an Omnidirectional Base Support system. The support system incorporates base plate 400, V-groove wheels 340, X-Y axis drive motors 370, stationary linear gears 380, and parallel V-tracks 320. Base 400 supports parallel tracks 320, which are positioned in the x-direction as shown by the arrow in FIG. 12 at lower center in the illustration. Rectangular frame 330 provides V-grooved wheels 340 which engage the x-direction tracks 320 for movement in the x-direction thereon. Rectangular frame 330 supports parallel tracks 320 in the y-direction as shown by the arrow in FIG. 12 at the mid-extreme left of the illustration. X-shaped frame 360 provides V-grooved wheels 340 as well which are positioned for engaging the y-direction tracks for motion in the y-direction. Base 400 and the rectangular frame 330 each also provide a linear gear 380 which engage linear motors 370 for providing propulsive forces to the rectangular frame 330 and the X-shaped frame 360. The lower portion of the planar X-Y axis support system allows independent planar movement in the x-direction, while the upper portion allows independent movement in the y-direction. The combination of these movements provides omnidirectional movement.

Drive forces are controlled by the flight controls system through the control decoding outputs which then provide an electrical signal to hydraulic, pneumatic or electrical actuating valves and they in turn provide the operational signal to drive motor 480. The simultaneous actuation of drive motors 370 results in an omnidirectional action placed upon the entire simulator. The simulator cockpit 20 may thus, move in the X-Y plane as well as vertically simultaneously providing full simulating of all possible inertial forces on the student.

In operation, the invention actuates its hydraulic/pneumatic devices, including the motor and the first and second linear actuators, to produce any combination of inertial forces at cockpit 20, including any combination of elevational change while yawing, rolling and/or pitching, and lateral or longitudinal acceleration, thrust or G-forces or thrust vectoring. The invention is enabled to simulate helicopter/airplane flight attributes through computer control of well-known standard hydraulic/pneumatic control mechanisms. The invention is also enabled to allow computer gaming simulation in conjunction with motion base actions.

While the invention has been described with reference to at least two preferred embodiments, it is to be clearly understood by those skilled in the art that the invention is not limited thereto. Rather, the scope of the invention is to be interpreted only in conjunction with the appended claims.

What is claimed is:

1. A flight simulator apparatus comprising a rotation actuating means enabled for continuous rotation of a cockpit in yaw motions about a vertical axis of rotation; a first linear actuating means engaged with the rotation actuating means, and enabled for vertical positioning of the cockpit and a second linear actuating means enabled for positioning the cockpit in pitch and roll motions.

2. The apparatus of claim 1 wherein the first and second linear actuating means are comprised of pressure actuated devices.

3. The apparatus of claim 1 wherein the rotation actuating means is a pressure actuated motor comprising a fixed portion and a rotating portion, the first linear actuating means engaged with the rotating portion, a piston of the first linear actuating means being engaged for rotation with, and translation within, the a cylinder thereof.

4. The apparatus of claim 1 further comprising a means for transferring electrical power from a fixed portion of the rotation actuating means to a rotating portion thereof.

5. The apparatus of claim 1 further comprising a means for transferring fluid pressure from a source of said fluid pressure within the cockpit to the rotation actuating means.

6. The apparatus of claim 1 further comprising a means for manipulation of the cockpit in simulating aircraft motions, wherein, at least one, operator induced simulated flight control command is modified by the manipulation means through a specified, at least one, other, operator non-induced, flight control command.

7. The apparatus of claim 1 further comprising a third linear actuating means for moving the apparatus with horizontal linear motion in a x-direction.

8. The apparatus of claim 7 further comprising a fourth linear actuating means for moving the apparatus with horizontal linear motion in a y-direction orthogonal to the x-direction.

9. The apparatus of claim 8 wherein the motions are implemented and controlled by a computer enabling manual control and automatic control thereof.
